(19) United States
(12) Patent Application Publication
(10) Pub. No.: US 2006/0012559 A1
(43) Pub. Date: Jan. 19, 2006

(54) Speaker apparatus using display window

(75) Inventor: Chung-Gu Kang, Seongnam (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/180,615

(22) Filed: Jul. 14, 2005

(30) Foreign Application Priority Data
Jul. 16, 2004 (KR) 2004-55737

(51) Int. Cl. G09G 3/34

(52) U.S. Cl. 345/108

(57) ABSTRACT

A speaker apparatus for a mobile communications terminal includes a display window acts as a speaker by using the display window as a vibration plate. As a result, sound in lower frequency range can be reproduced. In addition, through use of filters, frequency characteristics can be further enhanced.

### PRIORITY

This nonprovisional application claims priority under 35 U.S.C. § 119(a) on Patent Application No. 55737/2004 filed in Korea on Jul. 16, 2004, which is herein incorporated by reference.

### BACKGROUND OF THE INVENTION

1. Field of the Invention

The present invention relates to a speaker apparatus, and particularly, to a speaker apparatus for a mobile device using a display window.

2. Description of the Related Art

Development of communication technologies and increase in user requirements have recently enabled mobile communications terminals (hereinafter, referred to as a ‘terminal’) to provide multimedia functions such as music, videos, games, and the like in addition to the typical calling function. In order to provide these and other multimedia functions, as shown in FIG. 1, the terminal can come equipped with a highly functional loud speaker 10 independently of a typical receiver speaker.

The loud speaker 10 includes one or two circular speakers with a diameter of approximately 10˜15 mm, and is generally mounted in a case or in a hinge unit in case of a folder-type terminal.

However, the size of the loud speaker 10 is limited, typically to the diameter of 10˜15 mm, as shown in FIG. 2. As a result, the frequency response of the loud speaker is also limited, especially in a frequency region under 700 Hz (low sound). As the vibration plate of the speaker becomes smaller, the reproducing frequency response characteristic is moved toward higher frequencies. Lower frequency characteristics may be enhanced by installing speakers with larger diameters, but this option is limited due to the devices themselves getting smaller and smaller.

### SUMMARY OF THE INVENTION

Therefore, an object of the present invention is to provide a speaker apparatus capable of effectively reproducing sound in all frequency ranges including low frequency region by using a display window as a vibration plate.

To achieve these and other advantages and in accordance with the purpose of the present invention, as embodied and broadly described herein, a speaker apparatus may include a display window for protecting a display module; a support member for elastically supporting the display window; and a vibrator for vibrating the display window to generate a sound when an electrical audio signal is inputted.

The support member may be a coil spring which supports the corners and/or edges of the display window.

The vibrator may be positioned in the corners and/or the edges of the display window. The vibrator may include a permanent magnet or a magnetic material attached to the display window, and an electromagnet arranged to face the permanent magnet or magnetic material. The magnetic material can be a metal or any other material to which physical force may be exerted under magnetism The magnetism of the electromagnet may be varied according to a variance of an electrical audio signal, for example a variance in the strength of the electrical audio signal.

The display window, the support member, and the vibrator may be positioned in a cabinet which has a concave a chamber-like shape.

A stopping jaw may be formed at an outer circumference of the display window and a first rib corresponding to the stopping jaw may protrude from the cabinet. The stopping jaw and the first rib may have a gap therebetween so as not to influence each other while vibrating.

A second rib for preventing the display window from being separated from the terminal may protrude from the stopping jaw, and a damper may be installed between the first and second ribs.

The speaker apparatus using the display window may further include a filter for filtering the electrical audio signals received from an audio interface so that the electrical audio signals within a desired frequency range or ranges are provided to the vibrator.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a perspective view showing a mobile communications terminal provided with a related art loud speaker;

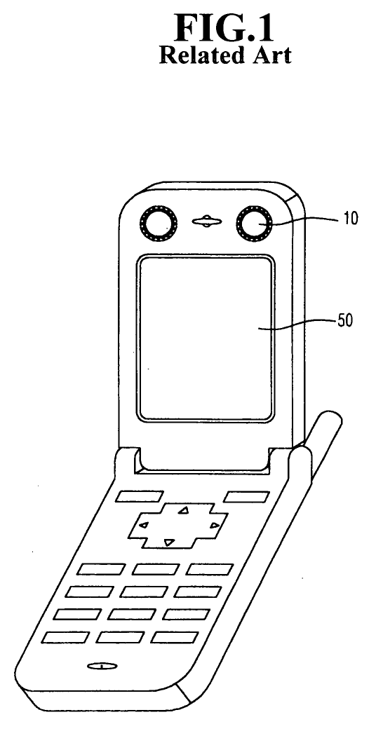

FIG. 2 shows frequency characteristics of outputs of the related art loud speaker;

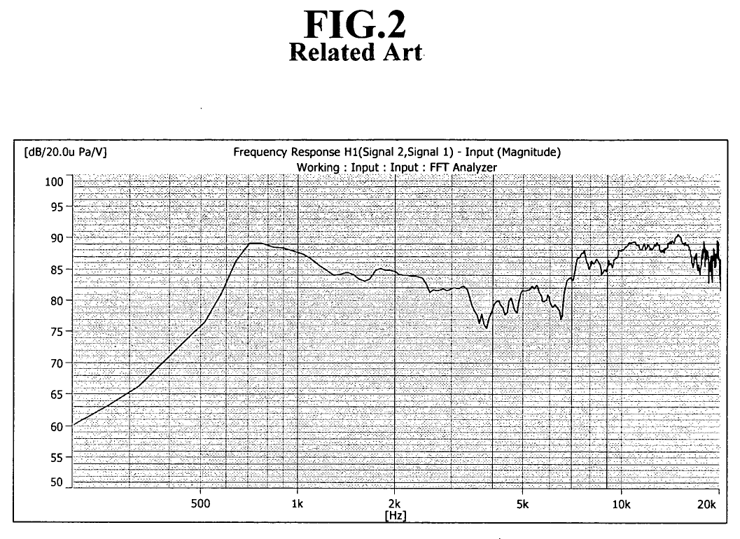

FIG. 3 is a partial sectional view showing a structure of a speaker apparatus using a display window according to an embodiment of the present invention;

FIG. 4 is a plane view showing positions of support member and vibrator of the speaker apparatus using the display window according to an embodiment of the present invention; and

FIG. 5 shows an example in which the speaker apparatus using the display window according to the embodiment of the present invention is coexistent with a loud speaker.

### DETAILED DESCRIPTION OF THE PREFERRED EMBODIMENTS

Reference will now be made in detail to the preferred embodiments of the present invention, examples of which are illustrated in the accompanying drawings.

In an embodiment of the present invention, a speaker apparatus is provided for a mobile communications terminal capable of effectively reproducing sound in a low frequency region by using a display window as a vibration plate. While a mobile communications terminal is discussed for simplicity, the embodiments of the invention are capable of being applied to any type of mobile devices, for example PDAs and MP3 players, where it is preferred to keep the overall dimensions of the mobile devices themselves to a minimum.

For this purpose, an aspect of the present invention embodies a speaker apparatus for using a display window as a vibration plate in which a permanent magnet or a magnetic material is mounted, for example in one or more corners or edges of the display window, and an electromagnet is positioned to face the permanent magnet or magnetic material. The size of the display window in each mobile device may be different depending on the type of the device. A folder-type communication terminal may use a display window with a cross-sectional length of about 50 mm, which corresponds to being approximately three to five times as long as the diameter of of the speaker typically used in the related art. In other words, the cross-sectional area of the display window is roughly nine to fifteen times as large as the speaker of the related art and therefore should have better low frequency characteristics.

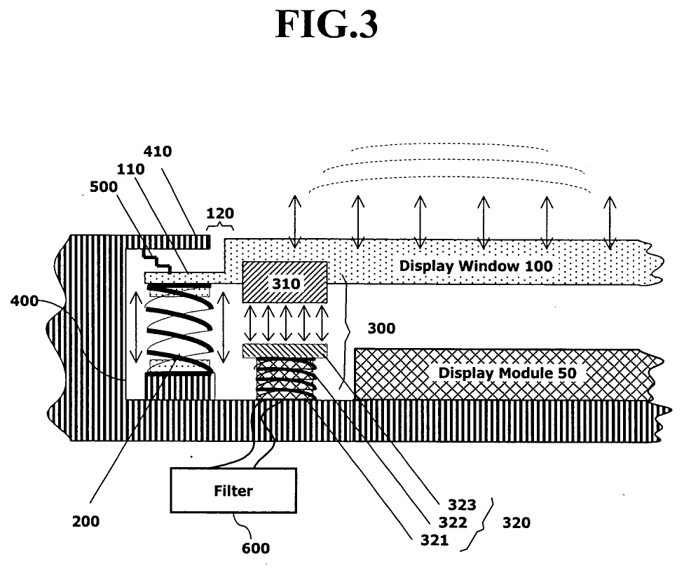

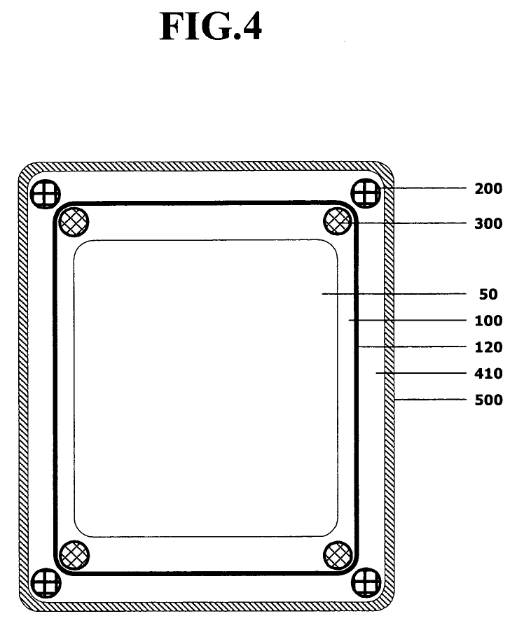

FIG. 3 is a partial sectional view showing a structure of a speaker apparatus using a display window according to an embodiment of the present invention, and FIG. 4 is a plane view showing installation positions of each support member and vibrator in the speaker apparatus using the display window according to an embodiment of the present invention.

Referring to FIG. 3, the speaker apparatus using the display window according to an embodiment of the present invention includes a display window 100 (i.e., LCD (Liquid Crystal Display) window) for protecting a display module 50; a support member 200 providing elastic support to the display window 100 to provide a predetermine range of gap distance between the display window 100 and the display module 50; and a vibrator 300 for vibrating the display window 100 when an electrical audio signal is received. Multiple support members 200 and the vibrators 300, as shown in FIG. 4, may be mounted in each of four corners of the display window 100. While not shown, the support members 200 and the vibrators 300 may also be mounted on the edges of the display window 100 as well. In general, the support members and the vibrators 300 may be placed in locations to minimize hinderance to view the display module and to maximize the vibration characteristics of the display window 100.

The display module 50 is used for visually displaying information. For instance, a LCD (Liquid Crystal Display) module may be used as the display module 50. The display module 50 is generally structurally weak to physical forces, such an impact from an external source. The display module 50 may be placed in the terminal casing to a predetermined depth. To protect the display module 50 from damage, the transparent display window 100 may be installed above the display module 50. Also a concaved portion or chamber-like portion of the terminal casing may serve as a cabinet 400. The shape of the cabinet 400 serves to reflect sound generated by the vibration to be emitted to the exterior in a single direction.

A shape of the display window 100 may be arbitrary, but is preferred to follow the shape of the display module 50. The display window 100 is preferably a bit larger than the display module 50 so as to provide maximum protection to the display module 50. A rib 110, which is a part of an outer circumference of the display window 100, may be positioned to be overlap with a rib 410 protruding from a side surface of the cabinet 400. The ribs 110 and 410 may act to prevent the display window 100 from being separated from the cabinet 400. A stopping jaw 120 may be provided at a portion where the display window 100 and the rib 410 overlap. The stopping jaw 120 and the rib 410 may have a predetermined gap distance therebetween so that the rib 410 does not act as an obstacle to disturb the vibration of the display window 100.

A damper 500 may be installed between the ribs 110 and 410 to prevent impurities from being introduced into the cabinet 400 and to allow the display window 100 to vibrate without being warped. The damper 500 may be formed from compression sponge or resin used in a typical cone speaker.

Any or all of the corners and/or edges of the display window 100 may be connected with the cabinet 400 by the support member 200. The display window 100 may be elastically supported by the support member 200 so that the display window 100 can be vibrated by the vibrator 300. The support member 200 may be formed from a coil spring or any other compressible material to elastically support the display window 100. The vibrator 300 may be installed between the display window 100 and the display module 50. When a force by the vibrator 300 is applied to the display window 100, the support member 200 vibrates and absorbs the load to restore the display window 100 to its original position.

The vibrator 300 may also be provided in any or all of the corners and/or edges of the display window 100. Each vibrator 300 may include a magnet or magnetic material 310 attached on the display module 50 and a corresponding magnetism generator 320 installed to face the magnet or magnetic material 310. The magnet or magnetic material 310 may be a permanent magnet or a metal. The magnetism generator 320 may be a magnet capable of generating a large magnetism. For instance, the magnetism generator 320 may include a solenoid 321 with a large magnetic permeability such as an iron core 322. A plate 323 may be provided at the end of the magnetism generator 320 to prevent the solenoid 321 from being separated.

When a time-variable electrical audio signal is provided to the solenoid 321, strength and/or direction in the magnetic field occurs causing the magnet or magnetic material 310 to move. Accordingly, the display window 100 vibrates to generate sound. If it is desired to limit the response of the display window 100 to only a certain range or ranges of frequencies, a filter 600 may be connected to the magnetism generator 320. For example, the filter 600 may be a low pass filter (LPF) to limit the response range of the display window 100 to those frequencies that cannot be adequately be reproduced by the speakers already provided in the device. Preferably, the filter 600 is added to an existing audio interface integrated circuit.

When the filter 600 is connected to the magnetism generator 320, an audio interface (not shown) managing the input/output of a microphone and speaker provided to the mobile device may output the electrical audio signal to the filter 600. The filter 600 may filter the electrical audio signal to provide the solenoid 321 signals corresponding to the allowed sound frequency range.

It should be noted that the filter 600 may also be a band pass and/or high pass filters. This provides the user an ability to enhance the frequency response suited to different types of music or environment. For example, it may be desirable to have better higher frequency characteristics for classical music. Indeed, the frequency response characteristics for the filter or filters 600 attached to the magnetism generator 320 may be adjustable so that the user is able to adjust the response characteristics of the display window 100 as well as any other speakers that may be provided on the mobile device.

An operation of a speaker apparatus using the display window according to an embodiment of the present invention will now be explained.

When sound is to be generated, the audio interface for managing the input/output of the microphone/speaker may output the electrical audio signal to the magnetism generator 320 directly or via the filter 600. As a result, a magnetic polarity and/or the strength generated by the magnetism generator 320 may be changed in response to the electrical audio signal. This change causes the magnet or magnetic material 310 mounted in the display window 100 move. As the magnet or magnetic material 310 moves, the display window vibrates to generate sound.

The magnetism of the magnetism generator 320 may be determined according to the electrical audio signal applied to the solenoid 321. The change in the magnetism generated by the magnetism generator 320 effects the amplitude of the vibration of the display window 100, namely, the strength of the audio generated by the vibration of the display window 100. As the display window 100 vibrates, the support member 200, for example a coil spring provides support to the display window 100 so that the display window can vibrate in a stable manner.

Therefore, a strong low frequency sound or any desired frequency range of sound can be generated by the vibration of the display window 100. When the filter 600 is mounted in the audio interface integrated circuit, the sound of a particular frequency range can be outputted.

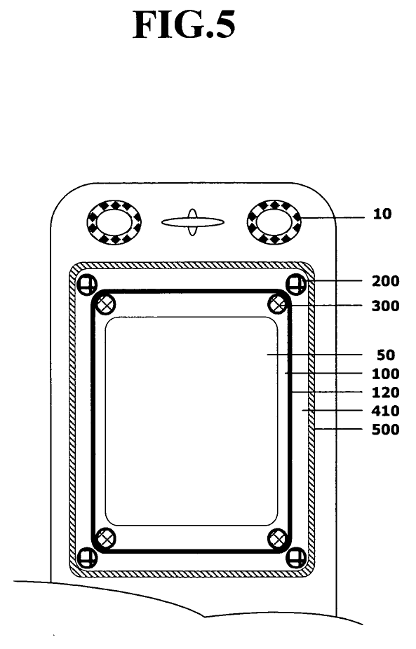

The operation of the speaker apparatus using the display window installed in the mobile device has been explained above. However, the invention not limited only to utilizing the display window. Conventional loud speakers, such as the related art loud speaker 10, as shown in FIG. 5, can be installed along with utilizing the display window. In this instance, the loud speaker 10 may be utilized as a tweeter for generally outputting sound in a high frequency range, and the display window may be utilized as a woofer for generally outputting sound in a low frequency bandwidth. Combined, the lout speakers 10 and the display 100 may reproduce sound more efficiently.

Also, one or more filters, such as the filter 600, may be utilized to enhance the sound quality generated from the loud speakers 10 as well as the display window 100. Further, the response characteristics of the filter 600 may be user adjustable.

As mentioned above, the speaker apparatus using the larger-sized display window than the conventional speaker as the vibration plate can more effectively reproduce sound in the low frequency region which has been difficult to be reproduced using the conventional speaker. Utilizing filters—low pass, band pass, high pass—can also enhance the sound quality.

Furthermore, since the display window is used as a vibration plate, extra space for installing the speaker apparatus is not required. As a result, the overall dimensions of the mobile device can be reduced.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

1. A speaker apparatus for a mobile device, comprising:
a display window; and
a vibrator for vibrating the display window to generate sound when an electrical audio signal is received.

2. The apparatus of claim 1, further comprising a support member for providing elastic support to the display window.

3. The apparatus of claim 2, wherein the support member supports one or more corners of the display window or one or more edges of the display window or any combination thereof.

4. The apparatus of claim 1, wherein the vibrator is positioned at a vicinity of one or more corners of the display window or at a vicinity of one or more edges of the display window or any combination thereof.

5. The apparatus of claim 1, wherein the vibrator comprises:
a magnet or a magnetic material attached the display window; and
a magnetism generator arranged to face the magnet or magnetic material, for generating a magnetism according to the electrical audio signal.

6. The apparatus of claim 5, wherein the magnetism generator is an electromagnet.

7. The apparatus of claim 1, wherein the vibrator is installed between the display window and a display module.

8. The apparatus of claim 1, wherein the display window and the vibrator are positioned in a cabinet which has a chamber-like shape.

9. The apparatus of claim 8, further comprising:
a stopping jaw positioned at an outer circumference of the display window; and
a first rib protruding from the cabinet to face the stopping jaw.

10. The apparatus of claim 9, wherein the stopping jaw and the first rib have a gap therebetween.

11. The apparatus of claim 9, further comprising:
a second rib protruding from the stopping jaw for preventing the display window from being separated from the mobile communications terminal; and
a damper installed between the first and second ribs.

12. The apparatus of claim 11, wherein the damper is formed from at least one of a compression sponge or a resin.

13. The apparatus of claim 1, further comprising a filter for receiving the electrical audio signals from an audio interface and outputting to the vibrator electrical audio signals within a particular frequency range.

14. A speaker apparatus for a mobile device, comprising:
a display window;
a first magnet or magnetic material mounted on the display window; and
a second magnet installed to face the first magnet or magnetic material for changing a magnetism according to an electrical audio signal outputted from an audio interface to vibrate the display window through an interaction with the first magnet or magnetic material.

15. The apparatus of claim 14, further comprising a support member for elastically supporting the display window.

16. The apparatus of claim 15, wherein the support member is a coil spring for supporting one or more corners of the display window or one or more edges of the display window or any combination thereof.

17. The apparatus of claim 14, wherein the first magnet or magnetic material is mounted on one or more corners of the display window or one or more edges of the display window or any combination thereof.

18. The apparatus of claim 14, wherein the first magnet or magnetic material is a permanent magnet and the second magnet is an electromagnet.

19. The apparatus of claim 14, further comprising a filter for outputting to the second magnet electrical audio signals of a particular frequency range by receiving and filtering electrical audio signals from an audio interface.

20. The apparatus of claim 13, wherein the filter is one of a low pass filter, a band pass filter, and a high pass filter.

21. The apparatus of claim 13, wherein a frequency response characteristics of the filter is adjustable.

22. The apparatus of claim 1, further comprising one or more loud speakers.

23. The apparatus of claim 19, wherein the filter is one of a low pass filter, a band pass filter, and a high pass filter.

24. The apparatus of claim 19, wherein a frequency response characteristics of the filter is adjustable.

25. The apparatus of claim 14, further comprising one or more loud speakers.
